(19) United States
(12) Patent Application Publication
(10) Pub. No.: US 2011/0034599 A1
(43) Pub. Date: Feb. 10, 2011

(54) CROSSLINKING ADHESIVES IN SOFTENERS

(75) Inventors: Sebastian Roos, Kelkheim (DE); Manfred Braum, Mainz (DE); Andreas Huether, Alzenau (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH

(21) Appl. No.: 12/937,911

(22) PCT Filed: Mar. 9, 2009
(86) PCT No.: PCT/EP09/52698

§ 371 Date: Oct. 14, 2010

(30) Foreign Application Priority Data
May 14, 2008 (DE) 10 2008 001 755.8

(51) Int. Cl. C08L 33/12; C08L 63/00; C08K 5/09; C08K 5/07; C08K 5/12; C08K 5/42

(52) U.S. Cl. 524/158; 524/521; 525/107; 524/322; 524/360; 524/296; 524/297

(57) ABSTRACT

The invention relates to a polymer mixture comprising a mixture of

polymer A, comprising polymers with a functional group —NRH and (meth)acrylates and

polymer B, comprising polymers having a functional group —NR—CH₂OH and (meth)acrylates

in dispersion in plasticizers or epoxy resins.

The invention relates to crosslinking adhesives in plasticizers.

Adhesive bonding denotes a fabrication method which comes under the heading of joining. Like welding and soldering, bonding is one of the fusional joining methods of fabrication technology. By bonding, adherend parts are connected fusionally by means of adhesive.

The adhesive attaches to the joining surface by means of physical (and also, though less commonly, chemical) interactions. This phenomenon of attachment is also referred to as adhesion. In contrast to welding or soldering, adhesive technology is one of the low-heat joining methods. And with bonding there is no process of diffusion between added material and adherend part. Consequently adhesive bonds often have lower strength than soldered bonds. This disadvantageous property can be compensated, however, by adhesive bonds with a large surface area.

From an industrial standpoint, adhesive bonding is a joining method which is able to connect virtually all materials to each other and to one another. The adhesive technology is particularly gentle, since it does not require high heat, which can lead to warping, cooling stresses or changes in the microstructure of the adherend parts. Nor does adhesive bonding necessitate any weakening holes in the adherend parts, as with screwing or riveting, for instance. Moreover, in adhesive bonding, the force is transferred areally from one adherend part to the other.

The technical implementation of adhesive bonding is challenging. The mechanical robustness of the attachment in the boundary layer between adhesive and adherend-part surface, and also its stability and other quality-determining properties, cannot be tested without destruction. From a technical standpoint, therefore, the bonding operation must be managed with such accomplishment that the result can be relied on without complete testing.

An adhesive bond is composed of the two adherend parts and the adhesive layer in between. At the phase boundaries, after wetting, which plays a significant part, there are interactions (physisorption, chemisorption) and mechanical fusion. Together, these three effects are responsible for the attachment force (adhesion). For optimum wetting, the adhesive must be liquid during the joining operation. It ultimately acquires its internal strength (cohesion) by means of physical setting processes or by means of chemical reaction.

A multiplicity of advantages over conventional connecting methods are promoting the increasing spread of adhesive bonding. In lightweight construction in particular, adhesives are readily used, since here it is possible to connect parts which are not very thick. Connecting such parts is problematic or even impossible to accomplish by means of thermal joining methods.

Adhesives may also serve simultaneously as sealants. The adhesives prevent the penetration of condensation and the attendant corrosion.

Adhesives can be used to join materials which are not amenable to a thermal joining method (glass to metal, wood to metal, aluminium to steel). The (typical) electrical and thermal insulation afforded by the adhesive prevents the formation of local cells and the associated contact corrosion in the case of metals. Furthermore, materials with different coefficients of thermal expansion can be bonded, since this joining method requires the supply of significantly less thermal energy to the adherend parts.

Within the automotive industry there are many production operations that are automated. In bodywork fabrication, for instance, numerous parts are bonded to one another. In that case, for example, the adhesive is applied to metal bodywork panels, which are assembled, cleaned and painted without the adhesive being cured. Only in one of the final fabrication steps is the component heated in order to bake the paint but also, at the same time, to cure the adhesive.

After the joining operation, and in the case of uncured adhesive as well, the components must be connected to one another so firmly that they cannot be separated in the course of the further fabrication steps by mechanical exposure, such as by transport movements, for example. There are various ways of accomplishing this. One common technique is the combination of adhesive bonding and spot welding. The weld spots that are applied fix the components, which can therefore pass through the fabrication operation unscathed. The ultimate strength of the components, as reflected, for example, in the crash properties, is achieved as a result of the bonding. Disadvantages of this method are the high manufacturing cost and complexity, resulting from the combination of two joining methods, and also the thermal exposure suffered by the adhesive as a result of the additional weld spots, leading to a potential weak point.

A further possibility associated with the fabrication of bodywork parts by adhesive bonding lies in the heating of the components directly after the joining operation, in order to induce preliminary curing of the adhesive at temperatures somewhat lower than the curing temperature. Thereafter the joined bodywork parts are processed further, are painted at the end of the fabrication operation, and subsequently, via a further thermal step, the paint is baked and the adhesive undergoes ultimate curing. A disadvantage in this case is the additional heating step, which is time-consuming and energy-intensive.

In the metal working industry, therefore, there is a desire for adhesives which combine good adhesive properties at low temperatures with good processing properties. It is preferably intended that there should be a preliminary bonding at only slightly elevated temperatures, and an ultimate bonding at high temperatures.

The object was to provide additives for adhesives. The object, furthermore, was to develop an adhesive which undergoes controlled cure via supply of heat and quickly exhibits good adhesion properties at slightly elevated temperatures. The adhesive ought, moreover, to be able to bond different materials. It ought to be a 1-component system, which avoids the disadvantageous aspects of 2-component systems, such as, for example, longer processing times as a result of the requisite mixing operations, and poorer performance as a result of incomplete mixing of the components. The intention, moreover, with a 1-component system is to utilize less costly and inconvenient processing systems than in the case of the 2-component systems.

This object has been achieved by means of polymer mixtures comprising a mixture of

polymer A, comprising polymers with a functional group —NRH and (meth)acrylates and

polymer B, comprising polymers having a functional group —NR—CH₂OH and (meth)acrylates in dispersion in plasticizers or epoxy resins.

Particular preference is given to polymer mixtures comprising a mixture of polymer A, comprising methacrylamide and other (meth)acrylates, and

a polymer B, comprising N-methylolmethacrylamide and other (meth)acrylates in dispersion in plasticizers or epoxy resins with plasticizers.

Surprisingly it has been found that the polymer mixtures of the invention in 1-component adhesives exhibit outstanding adhesive properties.

A common characterization of adhesives which have undergone preliminary curing is made using the concept of hand-fast bonding. Here, the attachment effect is defined by virtue of the adhesive bond withstanding tensile tests at about 1 MPa.

In adhesives, the polymer mixtures of the invention result in preliminary gelling at slight increases in temperature, temperatures between 80° C. and 120° C., preferably at about 100° C. During this gelling process, the active components of polymer A and those of polymer B are able to react with one another. This leads to preliminary crosslinking. This system is especially suitable for a reaction which proceeds very quickly.

It has been found that the preliminary crosslinking exhibits the required hand-fast bonding, the passing of a tensile test at 1 MPa.

As additives for adhesives, the polymer mixtures of the invention allow partial crosslinking at low temperatures.

On further heating to 160-200° C., preferably at 180° C., as is set, for example, during paint baking, the epoxy groups of the epoxy resins then react with the amines. This crosslinking leads to the ultimate curing of the adhesive. The adhesive obtains its ultimate strength—that is, two workpieces are durably and firmly connected to one another. Strengths of 20-30 MPa are typical for structural adhesives in automotive engineering.

The polymers are prepared by conventional polymerization processes.

Polymers used are (meth)acrylates and polymers that are polymerizable with (meth)acrylates. Preference is given to using methyl methacrylates. It is preferred to use >30% by weight, more preferably >50% by weight, of methyl methacrylates in the polymer mixtures.

The notation (meth)acrylate here denotes not only methacrylate, such as methyl methacrylate, ethyl methacrylate, etc., for example, but also acrylate, such as methyl acrylate, ethyl acrylate, etc., for example, and also mixtures of both.

The monomers used are widely known. They include, among others, (meth)acrylates which derive from saturated alcohols, such as, for example, methyl (meth)acrylates, ethyl (meth)acrylates, propyl (meth)acrylates, butyl (meth)acrylates, pentyl (meth)acrylates and 2-ethylhexyl (meth)acrylate, especially methyl acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate; (meth)acrylates which derive from unsaturated alcohols, such as, for example, oleyl (meth)acrylate, 2-propynyl (meth)acrylate, allyl (meth)acrylate, vinyl (meth)acrylate; aryl (meth)acrylates, such as benzyl (meth)acrylate or phenyl (meth)acrylate, in which the aryl radicals may in each case be unsubstituted or substituted up to four times; cycloalkyl (meth)acrylates, such as 3-vinylcyclohexyl (meth)acrylate, bornyl (meth)acrylate; hydroxyalkyl (meth)acrylates, such as 3-hydroxypropyl (meth)acrylate, 3,4-dihydroxybutyl (meth)acrylate, 2-hydroxyethyl (meth)acrylate, 2-hydroxypropyl (meth)acrylate; glycol di(meth)acrylates, such as 1,4-butane-diol (meth)acrylate, (meth)acrylates of ether alcohols, such as tetrahydrofurfuryl (meth)acrylate, vinyloxyethoxyethyl (meth)acrylate; amides and nitriles of (meth)acrylic acid, such as N-(3-dimethylaminopropyl)(meth)acrylamide, N-(diethylphosphono)(meth)acrylamide, 1-methacryloylamido-2-methyl-2-propanol; sulphur-containing methacrylates, such as ethylsulphinylethyl (meth)acrylate, 4-thiocyanatobutyl (meth)acrylate, ethylsulphonylethyl (meth)acrylate, thiocyanatomethyl (meth)acrylate, methylsulphinylmethyl (meth)acrylate, bis((meth)acryloyloxyethyl) sulphide; polyfunctional (meth)acrylates, such as trimethylolpropane tri(meth)acrylate, and also mixtures thereof.

In addition to the (meth)acrylates set out above, the compositions for polymerization may also contain further unsaturated monomers which are copolymerizable with methyl methacrylate and the aforementioned (meth)acrylates.

Polymer A contains 0.01-10% by weight of polymers having a functional group —NRH, preferably 0.5-1.5% by weight.

Polymer B contains 0.01-10% by weight of polymers having a functional group —NR—CH2OH, preferably 0.5-1.5% by weight.

Polymer A contains 0.01-10% by weight of methacrylamide, preferably 0.5-1.5% by weight.

Polymer B contains 0.01-10% by weight of N-methylolmethacrylamide, preferably 0.5-1.5% by weight.

The polymer A is mixed after spray drying, as a powder, with the spray-dried polymer B.

The polymers A and B are dispersed in organic plasticizers. Preferably they are dispersed in organic plasticizers selected from the group of low-volatility esters, fats, oils and camphor, preferably from the group of phthalates, more preferably from the group of diisononyl phthalates, diethylhexyl phthalates and dioctyl phthalates. Additionally it is possible to use plasticizers selected from the group of alkylsulphonic esters of phenol, preferably mesamol or hexamol. The polymers A and B are not in solution.

Of particular preference the polymers A and B are dispersed in epoxy resins.

Processes for preparing the polymer mixtures of the invention are known to the person skilled in the art. One preferred process is characterized in that polymer A is spray-dried and polymer B is spray-dried and then the powders are mixed and thereafter are dispersed in organic solvents or epoxy resins with plasticizers.

The polymers of the invention can be used as additives in adhesives. These adhesives have a broad field of application. For example, structural adhesives having crash properties are one important field of application. In aerospace engineering as well, however, there are fields of application for these adhesives, such as, for example, wing units bonded to the fuselage. The construction of wind turbine systems also operates with the adhesives of the invention.

The materials can also be used in electronics; for example, surface-mounted electronic devices (SMD) are first adhered to the board and then soldered. They are also used for copper-clad printed circuit boards.

A further field of application is in adhesive tapes, such as adhesive carpet tapes, parcel tape, industrial adhesive tape, universal adhesive tape, armoured tape, fabric-backed tapes and the like, for example. These tapes are normally composed of a sheet and a thin film of adhesive. Carrier sheets used are usually PVC or PP, and also fabrics, which are used to increase the strength of the adhesive tapes.

### EXAMPLES

Synthesis of Polymer A

166.25 g of methyl methacrylate and 166.25 g of butyl methacrylate are weighed out into a glass beaker with 14.0 g of hexadecane. 519.3 g of fully deionized water are placed in a second glass beaker and 116.7 g of 15% strength sodium dodecyl sulphate (Texapon) are added and mixed. Subsequently 17.5 g of methacrylamide are added.

The two mixtures are combined and homogenized. The mixture is cooled to room temperature in an ice bath, and polymerization is initiated in a stirring apparatus with 0.70 g of ammonium peroxosulphate and 0.70 g of sodium hydrogen sulphite and also 0.35 g of Fe(II) sulphate. The batch is stirred at a temperature of 75° C. for 2 hours.

The primary particle size is 59 nm.

The residual monomer content is 0.11% of methyl methacrylate, 0.16% of methacrylamide.

The polymers are dried in a drying oven at 140° C. overnight.

Synthesis of Polymer B

166.25 g of methyl methacrylate and 166.25 g of butyl methacrylate are weighed out into a glass beaker with 14.0 g of hexadecane. 507.6 g of fully deionized water are placed in a second glass beaker and 116.7 g of 15% strength sodium dodecyl sulphate (Texapon) are added and mixed. Subsequently 29.2 g of a 60% strength solution of N-methylolmethacrylamide in water are added.

The two mixtures are combined and homogenized. The mixture is cooled to room temperature in an ice bath, and polymerization is initiated in a stirring apparatus with 0.70 g of ammonium peroxosulphate and 0.70 g of sodium hydrogen sulphite and also 0.35 g of Fe(II) sulphate. The batch is stirred at a temperature of 75° C. for 2 hours.

The primary particle size is 55 nm.

The polymers are dried in a drying oven at 140° C. overnight.

Comparative Experiment

175.0 g of methyl methacrylate and 175.0 g of butyl methacrylate are weighed out into a glass beaker with 14.0 g of hexadecane. 519.6 g of fully deionized water are placed in a second glass beaker and 116.7 g of 15% strength sodium dodecyl sulphate (Texapon) are added and mixed.

The two mixtures are combined and homogenized. The mixture is cooled to room temperature in an ice bath, and polymerization is initiated in a stirring apparatus with 0.70 g of ammonium peroxosulphate and 0.70 g of sodium hydrogen sulphite and also 0.35 g of Fe(II) sulphate. The batch is stirred at a temperature of 75° C. for 2 hours.

The primary particle size is 57 nm.

The polymers are dried in a drying oven at 140° C. overnight.

A mixture is prepared comprising 25% of polymer A, 25% of polymer B and 50% of Jayflex DINP (diisononyl phthalate). Polymer A and polymer B are dispersed in the Jayflex DINP plasticizer at 2000 rpm for 5 minutes.

Evacuation then takes place in a Planimax (vacuum stirrer) at 300 rpm for 10 minutes.

Viscosity Measurements

In a rheological analysis this mixture is subjected to a temperature/viscosity curve.

The temperature/flow curve was measured using the Thermo Rheostress RS 600, with a plate (PP20Ti)/plate measuring installation.

The heating rate was 5° C./min.

Polymer A and Polymer B

Viscosity at 40° C. 625 mPas

Viscosity at 140° C. 69 990 mPas

Comparative Experiment

Viscosity at 40° C. 9870 mPas

Viscosity at 140° C. 3722 mPas

1. Polymer mixture comprising a mixture of
polymer A, comprising polymers with a functional group —NRH and (meth)acrylates and
polymer B, comprising polymers having a functional group —NR—CH₂OH and (meth)acrylates
in dispersion in plasticizers or epoxy resins.

2. Polymer mixture comprising a mixture of polymer A, comprising methacrylamide and other (meth)acrylates, and a polymer B, comprising N-methylolmethacrylamide and other (meth)acrylates in dispersion in plasticizers or epoxy resins with plasticizers.

3. Polymer mixture according to claim 1, characterized in that polymer A contains 0.01-10% methacrylamide.

4. Polymer mixture according to claim 1, characterized in that polymer B contains 0.01-10% N-methylolmethacrylamide.

5. Polymer mixture according to claim 1, characterized in that the (meth)acrylates are selected from the group of methyl (meth)acrylates, ethyl (meth)acrylates, propyl (meth)acrylates, butyl (meth)acrylates, pentyl (meth)acrylates and 2-ethylhexyl (meth)acrylate and also mixtures thereof.

6. Polymer mixture according to claim 1, characterized in that the plasticizers are selected from the group of low-volatility esters, fats, oils and camphor.

7. Polymer mixture according to claim 6, characterized in that the plasticizers are selected from the group of phthalates.

8. Polymer mixture according to claim 7, characterized in that the plasticizers are selected from the group of diisononyl phthalate, diethylhexyl phthalate and dioctyl phthalate.

9. Polymer mixture according to claim 6, characterized in that the plasticizers are selected from the group of alkylsulphonic esters of phenol, preferably mesamol or hexamol.

10. Polymer mixture according to claim 1, characterized in that the polymer mixture is incorporated into epoxy resins.

11. Polymer mixture according to claim 1, characterized in that the polymers A and polymers B gel in plasticizers or epoxy resins by heating.

12. Polymer mixture according to claim 1, characterized in that the polymers A and polymers B react chemically in plasticizers or epoxy resins by heating.

13. Process for preparing the polymer mixture according to claim 1, characterized in that polymer A is spray-dried and polymer B is spray-dried and then the powders are mixed and thereafter are dispersed in organic solvents or epoxy resins with plasticizers.

14. Adhesives comprising polymer mixtures according to claim 1.

15. Use of the polymer mixtures according to claim 1 in adhesives.

16. Use of the adhesives according to claim 15 in automotive engineering, rail-vehicle engineering, aircraft construction or wind turbines.

17. Use of the adhesives according to claim 15 for electronic devices or copper-clad printed circuit boards.

18. Use of the adhesives according to claim 15 in adhesive tapes.
